(19) United States
(12) Patent Application Publication
(10) Pub. No.: US 2015/0000500 A1
(43) Pub. Date: Jan. 1, 2015

(54) PIANO ACTION

(71) Applicant: KABUSHIKI KAISHA KAWAI GAKKI SEISAKUSHO, Hamamatsu-shi (JP)

(72) Inventor: Yasushi TERAI, Hamamatsu-shi (JP)

(21) Appl. No.: 14/308,437

(22) Filed: Jun. 18, 2014

(30) Foreign Application Priority Data
Jun. 27, 2013 (JP) 2013-135473

(51) Int. Cl. G10C 1/02

(52) U.S. Cl. CPC G10C 1/02
USPC 84/242

(57) ABSTRACT

Obtained is a structure of a piano action by which excellent playing reproducibility is secured even in a case of playing by repeatedly striking a key at an extremely high speed. In a piano action including a plurality of hammers 31 for striking keys, hammer shanks 32 that support the hammers turnably, hammer rails 1 that restrict the hammer shanks 32 from turning after the hammers strike strings, and hammer cushions (shock absorbing materials) 100 that are placed on the hammer rails and absorb motion energy generated by collision with the hammer shanks 32, the hammer cushions (shock absorbing materials) 100 are disposed at an angle so as not to become parallel to contact surfaces of the hammer shanks 32.

### CROSS-REFERENCE TO RELATED APPLICATION

This application claims priority to and the benefit of Japanese Patent Application Number 2013-135473, filed on Jun. 27, 2013, the entire disclosure of which is incorporated by reference.

### TECHNICAL FIELD

The present invention relates to a piano action in a hammer rail device for an upright piano, and specifically, to a structure of a piano action excellent in playing performance.

### BACKGROUND ART

In a hammer rail device for an upright piano, hammers for striking strings are supported by hammer shanks that freely turn, and after striking a string, the striking hammer turns in a direction opposite to the string due to inertia force. The movement of the hammer for striking a string is stopped by collision of the hammer shank with a hammer rail. At this time, to prevent collision noise, etc., from being generated by the stopping of the hammer shank, a hammer cushion made of a material such as felt is attached to the contact surface of the hammer rail.

With the above-described structure of the piano action, due to great inertia of the hammer, when the hammer shank collides with the hammer cushion and rebounds, in a case of playing by repeatedly striking a key at an extremely high speed, the hammer rebounding position is not stable, so that an idle strike (producing no sound) may occur, and this hinders good performance.

Therefore, to reduce the coefficient of restitution on the hammer rail and absorb the motion energy of the hammer shank at the time of collision, for example, as shown in Patent Literature 1, a structure was proposed in which the hammer cushion made of urethane, etc., is formed as a material with shock absorbing characteristics, and the surface of the hammer cushion is provided with a cushion guard with a slit for absorbing vibration caused by hammer shank collision.

### CITATION LIST

### Patent Literature

Patent Literature 1: Japanese Published Examined Utility Model Application No. H06-8634)

### SUMMARY OF INVENTION

### Technical Problem

However, with the above-described structure of a piano action, a phenomenon was confirmed in which, in the case where the coefficient of restitution of the hammer cushion was reduced (for example, by using resin such as urethane), the collision noise on the contact surface of the hammer shank increased.

The present invention was proposed in view of the above-described circumstances, and an object thereof is to provide a structure of a piano cushion that can prevent collision noise from being generated by the hammer cushions, and secure excellent playing reproducibility even in a case of playing by repeatedly striking a key at an extremely high speed.

### Solution to Problem

To achieve the above object, the present invention of the claim 1 is a piano action comprising a plurality of hammers for striking strings; hammer shanks that support the respective hammers turnably; hammer rails that restrict the hammer shanks from turning after the hammers strike strings, and hammer cushions that are placed on the hammer rails and absorb motion energy generated by collision with the hammer shanks, wherein

the hammer cushions are disposed at an angle so as not to become parallel to contact surfaces of the hammer shanks.

Claim 2 is the piano action according to claim 1, wherein the hammer cushions are shaped so that when the hammer shanks collide with the hammer cushions, the hammer shanks come into contact with parts of the hammer cushions first.

Claim 3 is the piano action according to claim 1, wherein the hammer cushions are shaped so that when the hammer shanks collide with the hammer cushions, lower positions of the hammer shanks come into contact with the hammer cushions first.

Claim 4 is the piano action according to any one of claims 1 to 3, wherein each of the hammer cushions is made of low repulsion urethane resin.

Claim 5 is the piano action according to claim 1, wherein each of the hammer cushions is made of a felt material and a low repulsion urethane resin material that are divided in the longitudinal direction of the hammer shank.

Claim 6 is the piano action according to claim 5, wherein the low repulsion urethane resins of the hammer cushions are disposed at an angle so as not to become parallel to contact surfaces of the hammer shanks.

### ADVANTAGEOUS EFFECTS OF INVENTION

With the piano action according to the present invention, by disposing the hammer cushion on the hammer rail at an angle so as not to become parallel to the contact surface of the hammer shank, the hammer shank comes into contact with a part of the hammer cushion first, and then the hammer shank entirely comes into contact with the hammer cushion due to subsequent warping of the hammer cushion, so that an excellent shock absorbing effect can be obtained.

In addition, the hammer shank comes into contact with a part of the hammer cushion first, so that the area of the contact portion at the start of collision is reduced, and accordingly, the collision noise can be reduced.

### BRIEF DESCRIPTION OF DRAWINGS

FIG. 1 is a side sectional explanatory view showing an entire structure of a hammer rail device with a piano action according to an embodiment of the present invention.

FIG. 2 is a side explanatory view of a piano action portion in the hammer rail device shown in FIG. 1.

FIG. 3A is a graph showing repulsion force characteristics of shock absorbing materials, and a repulsion force characteristic chart in a case where needle felt is used.

FIG. 3B is a graph showing repulsion force characteristics of shock absorbing materials, and a repulsion force characteristic chart in a case where low repulsion urethane resin is used.

FIG. 4 is a side explanatory view of a piano action portion showing an example of another embodiment.

FIG. 5 is a side explanatory view of a piano action portion showing an example of another embodiment.

FIG. 6 is a side explanatory view of a piano action portion showing an example of another embodiment.

FIG. 7 is a side explanatory view of a piano action portion showing an example of another embodiment.

FIG. 8 is a side explanatory view of a piano action portion showing an example of another embodiment.

FIG. 9 is a side explanatory view of a piano action portion showing an example of another embodiment.

FIG. 10 is a side explanatory view of a piano action portion showing an example of another embodiment.

FIG. 11 is a side explanatory view of a piano action portion showing an example of another embodiment.

FIG. 12 is a side explanatory view of a piano action portion showing an example of another embodiment.

### DESCRIPTION OF EMBODIMENTS

Hereinafter, an example of an embodiment of the present invention is described with reference to the drawings.

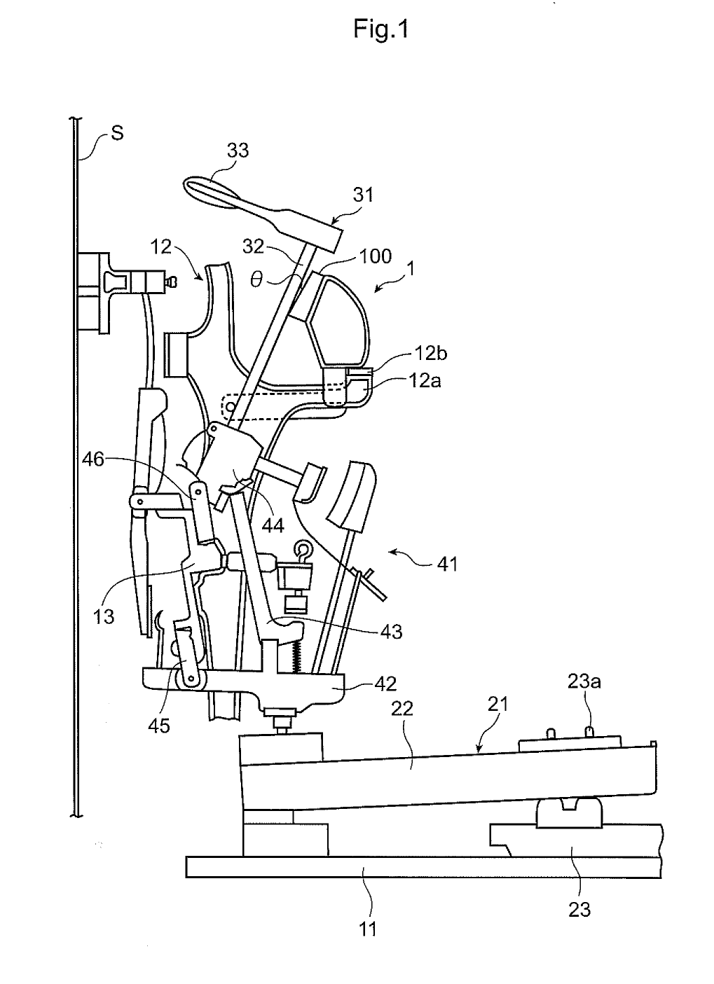

A hammer rail device with a piano action according to an embodiment of the present invention includes a keyboard 21, hammers 31, and actions 41, etc., as shown in FIG. 1.

FIG. 1 shows a key releasing state of the hammer rail device, and description is given by defining the player side as “front” and the opposite side as “rear” as viewed from the player side. In all drawings including this figure, for convenience, hatching is omitted.

The keyboard 21 consists of many keys 22 (only one is illustrated) lined up in the left-right direction (depth direction of FIG. 1). Each key 22 is supported turnably by a balance pin 23a provided upright on a reed 23, and the reed 23 is attached to the upper surface of a keybed 11.

The hammer 31 is provided for each key 22 (only one is illustrated), and each hammer 31 includes a hammer shank 32 formed into a thin and long bar shape circular in section and a hammer head 33 provided on the upper end portion of the hammer shank 32.

The hammer shank 32 is provided upright on the upper surface of the butt 44 described later of the action 41, and extends in the up-down direction.

In the key releasing state, the hammer shank 32 is in contact with a hammer cushion (shock absorbing material) 100 of the hammer rail 1 described later, and the hammer head 33 faces a string S taut vertically on the rear side. The hammer rail 1 and the shock absorbing material 100 disposed on the hammer rail are formed to be long and continuous in the left-right direction (front-back direction of FIG. 1).

The action 41 includes wippens 42, jacks 43, and the butts 44 provided for each of the keys 22, and is attached to a center rail 13 extending long in the left-right direction, and disposed above the rear end portion of the keyboard 21.

The wippen 42 and butt 44 are supported turnably on a wippen flange 45 and a butt flange 46 attached to the center rail 13, respectively.

The wippens 42 in the key releasing state are placed on the rear end portions of the corresponding keys 22.

The jacks 43 are supported turnably on the upper end portions of the wippens 42, and in the key releasing state, the jacks are engaged with the butts 44 from below.

With the above-described constitution, when the key 22 is pressed, the wippen 42 is pushed up by the key 22 and accordingly turns upward together with the jack 43, and accordingly, the jack 43 pushes up the butt 44.

By this operation, the hammer 31 turns toward the string S together with the butt 44 and separates from the hammer rail 1, and thereafter, the hammer head 33 strikes the string S to produce a piano sound.

Then, when key pressing is ended, the wippen 42, the jack 43, and the hammer 31 return to the original positions before key pressing, and the hammer 31 comes into contact with the hammer cushion (shock absorbing material) 100 of the hammer rail 1.

In this series of operations, when the hammer shank 32 collides with the hammer cushion (shock absorbing material) 100 and rebounds, in some cases of playing by repeatedly striking a key at an extremely high speed, the rebounding position of the hammer 31 is not stable and the operation becomes unstable, so that an idle strike (producing no sound) occurs. The present invention provides a structure for preventing this phenomenon from occurring by devising the shape of the hammer cushion (shock absorbing material) 100 of the hammer rail 1.

In addition, the hammer rail device includes the hammer rails 1 and brackets 12 that support the hammer rails 1 turnably. The brackets 12 are provided at the left end portion (end portion of the low note side), the center, and the right end portion (end portion of the high note side) of the rear end portion of the keybed 11, respectively (only the bracket on the right end portion is illustrated). Each bracket 12 is made of, for example, aluminum light alloy and extends in the up-down direction, and the upper end portion of each bracket is fixed to a post by an action bolt (these are not illustrated), and the lower end portion is fixed to an action base (not illustrated) placed on the keybed 11.

The bracket 12 includes a rail support portion 12a (stopper) extending forward from the center of the bracket, and to the front end portion of the upper surface of the rail support portion 12a, a shock absorbing material 12b made of, for example, felt is bonded.

To the lower portion of the bracket 12, the above-described center rail 13 is fixed.

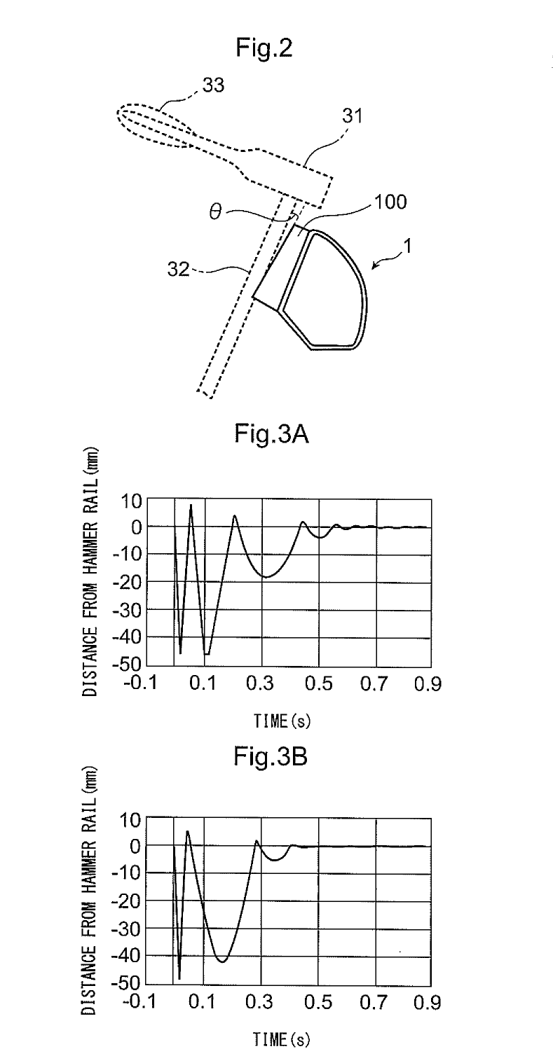

Next, a constitution of the characteristic portion of the piano action according to the present embodiment is described with reference to FIG. 1 and FIG. 2.

As the shape of the conventional hammer cushion (shock absorbing material) 100 disposed on the hammer rail 1, the hammer shank 32 and the upper surface of the hammer cushion 100 are positioned in parallel to each other and form contact surfaces, however, the hammer cushion 100 according to the present embodiment is disposed at an angle so as not to become parallel to the contact surface of the hammer shank 32.

Specifically, although the hammer cushion in the conventional structure is shaped so that the hammer shank 32 comes into contact with the entire hammer cushion 100, the hammer cushion is shaped so that the hammer shank 32 comes into contact with a part of the hammer cushion 100 first and then entirely comes into contact with the entire hammer cushion 100 due to subsequent warping of the shock absorbing material 100. In detail, the hammer cushion is formed so that a predetermined angle θ formed between the hammer shank 32 and the hammer cushion 100 when the side surface position of the hammer shank 32 is at a position at which the side surface position of the hammer shank 32 starts to come into contact with the upper surface of the hammer cushion 100 is 3 degrees or more.

For example, in the example shown in FIG. 1 and FIG. 2, by placing the hammer cushion 100 having a shock absorbing material the upper surface of which is sloped by a predetermined angle θ on the hammer rail 1 having the same shape as conventionally, the closer to the lower side of the hammer shank 32, the more the upper surface of the shock absorbing material protrudes with respect to the hammer rail 1.

The hammer cushion (shock absorbing material) 100 is entirely made of low repulsion urethane resin. The low repulsion urethane resin is excellent in repulsion force absorbability as compared with the repulsion force characteristics of the needle felt conventionally used, and in detail, as compared with the characteristics of needle felt (FIG. 3A), low repulsion urethane resin has characteristics that shorten the motion convergence time of the hammer shank (FIG. 3B). The characteristic graphs shown in FIGS. 3A & 3B show the results of measurements of the distance (vertical axis) of the hammer shank 32 from the hammer rail 1 with respect to the time (horizontal axis).

The modulus of repulsion elasticity of low repulsion urethane resin to be used for the hammer cushion (shock absorbing material) 100 is preferably approximately 0.20 or less.

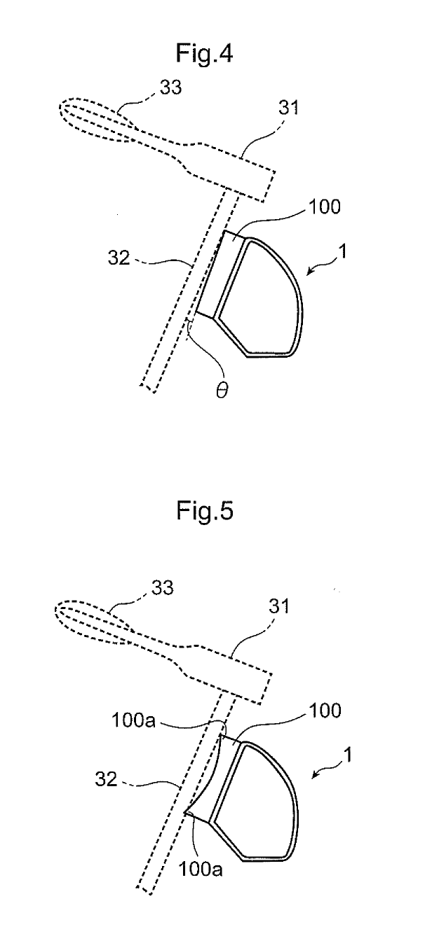

FIG. 4 shows another embodiment of the piano action as an example in which the hammer cushion (shock absorbing material) 100 is shaped so that an upper position of the hammer shank 32 comes into contact with the hammer cushion first when the hammer shank 32 collides with the hammer cushion. In FIG. 4, portions constituted similar to those in FIG. 1 and FIG. 2 are designated by the same reference symbols.

In this example, the hammer cushion (shock absorbing material) 100 is entirely made of low repulsion urethane resin.

FIG. 5 shows another embodiment of the piano action in which the upper and lower ends of the shape of the hammer cushion (shock absorbing material) 100 are provided with protrusions 100a. In this case, when the hammer shank 32 collides with the shock absorbing material 100, the hammer shank 32 comes into contact with the protrusions 100a first. In FIG. 5, portions constituted similar to those in FIG. 1 and FIG. 2 are designated by the same reference symbols.

In this example, the hammer cushion (shock absorbing material) 100 is entirely made of low repulsion urethane resin.

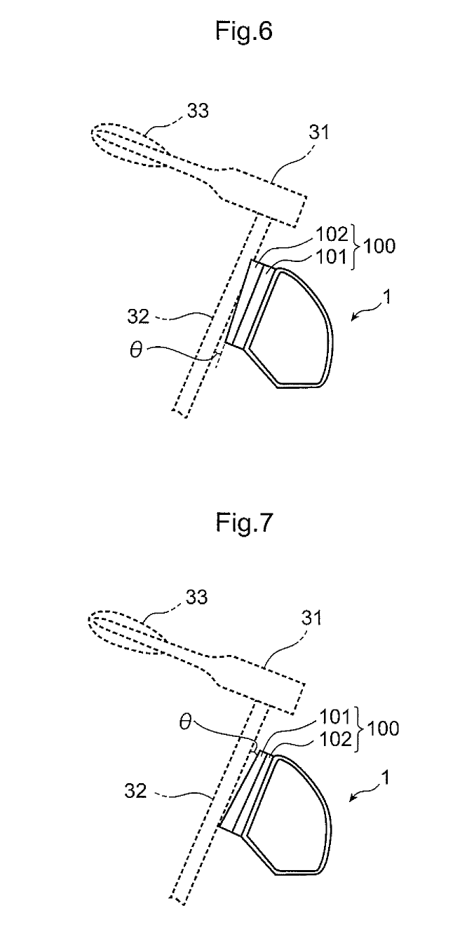

FIG. 6 shows another embodiment of the piano action in which, although the shape of the hammer cushion (shock absorbing material) 100 is the same as that in FIG. 4, the shock absorbing material 100 is formed to have a two-layered structure including a low repulsion urethane resin material 101 on the hammer rail 1 side and a felt material 102 disposed on the low repulsion urethane resin material. In this case, when the hammer shank 32 collides with the shock absorbing material 100, the hammer shank comes into contact with an upper position of the felt material 102 first. In FIG. 6, portions constituted similar to those in FIG. 1 and FIG. 2 are designated by the same reference symbols.

FIG. 7 shows another embodiment of the piano action in which, although the shape of the hammer cushion (shock absorbing material) 100 is the same as that in FIG. 2, the shock absorbing material 100 is formed to have a two-layered structure including a felt material 102 on the hammer rail 1 side and a low repulsion urethane resin material 101 disposed on the felt material. In this case, when the hammer shank 32 collides with the shock absorbing material 100, the hammer shank 32 comes into contact with a lower position of the low repulsion urethane resin material 101 first. In FIG. 7, portions constituted similar to those in FIG. 1 and FIG. 2 are designated by the same reference symbols.

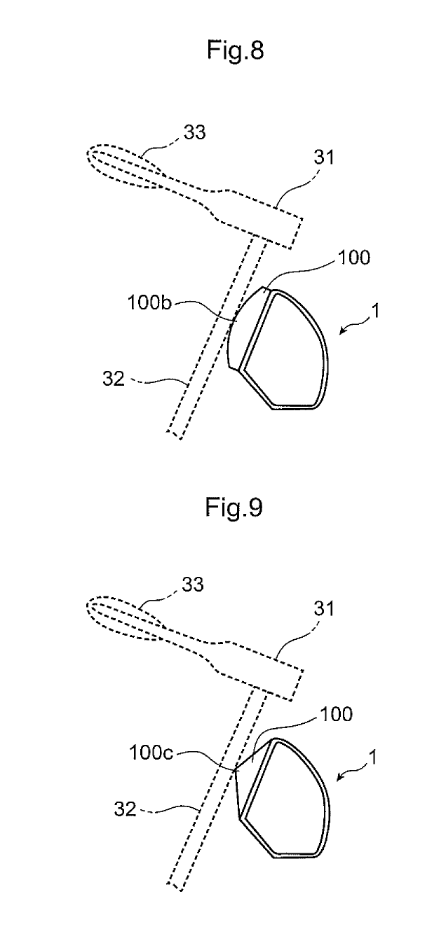

FIG. 8 shows another embodiment of the piano action in which, as the shape of the hammer cushion (shock absorbing material) 100, an arc-shaped protrusion 100b with an arc-shaped section is provided at the center position. In this case, when the hammer shank collides with the shock absorbing material 100, the hammer shank comes into contact with the arc-shaped protrusion 100b at the center first. In FIG. 8, portions constituted similar to those in FIG. 1 and FIG. 2 are designated by the same reference symbols.

In this example, the hammer cushion (shock absorbing material) 100 is entirely made of low repulsion urethane resin.

FIG. 9 shows another embodiment of the piano action in which, as the shape of the hammer cushion (shock absorbing material) 100, a mountain-shaped protrusion 100c is provided at the center position. In this case, when the hammer shank 32 collides with the shock absorbing material 100, the hammer shank 32 comes into line contact with the mountain-shaped protrusion 100c at the center first. In FIG. 9, portions constituted similar to those in FIG. 1 and FIG. 2 are designated by the same reference symbols.

In this example, the hammer cushion (shock absorbing material) 100 is entirely made of low repulsion urethane resin.

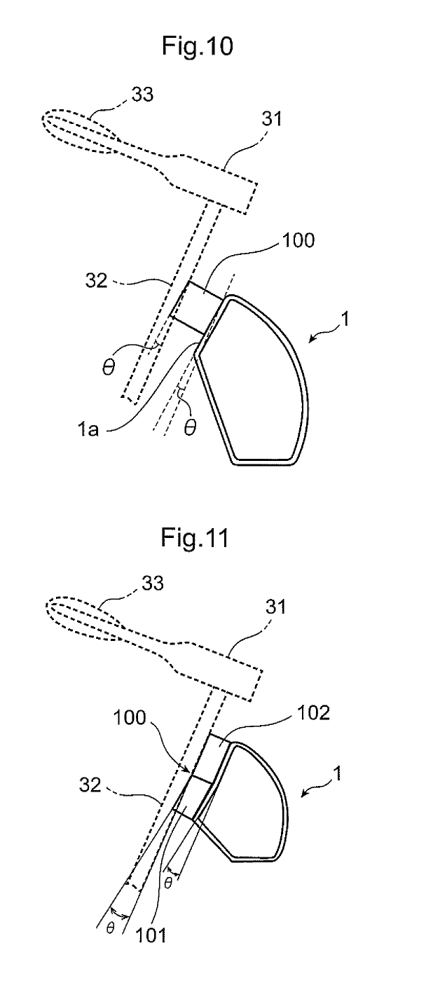

FIG. 10 shows another embodiment of the piano action in which an upper surface 1a of the hammer rail 1 is sloped (predetermined angle θ) with respect to the conventional hammer rail 1 so that when the shock absorbing material 100 placed on the hammer rail collides with the hammer shank 32, a lower position of the hammer shank 32 comes into contact with the shock absorbing material first.

Specifically, the hammer cushion (shock absorbing material) 100 itself is shaped to be rectangular in section without being sloped on the upper surface side so that the hammer cushion has an angle so as not to become parallel to the contact surface of the hammer shank 32 when the hammer cushion is placed on the upper surface 1a of the hammer rail 1. In FIG. 10, portions constituted similar to those in FIG. 1 and FIG. 2 are designated by the same reference symbols.

In this example, the hammer cushion (shock absorbing material) 100 is entirely made of low repulsion urethane resin.

FIG. 11 shows another embodiment of the piano action in which the hammer cushion (shock absorbing material) 100 is made of the low repulsion urethane resin material 101 and the felt material 102 that are divided in the longitudinal direction of the hammer shank 32.

Specifically, a slope surface (predetermined angle θ) is formed at a lower position on the upper surface of the hammer rail 1, the low repulsion urethane resin material 101 being rectangular in section is placed on this position, and on an upper position thereof, a felt material 102 being rectangular in section is placed so that when the hammer cushion (shock absorbing material) 100 collides with the hammer shank 32, a lower position of the hammer shank 32 comes into contact with the low repulsion urethane resin material 101 first. In FIG. 11, portions constituted similar to those in FIG. 1 and FIG. 2 are designated by the same reference symbols.

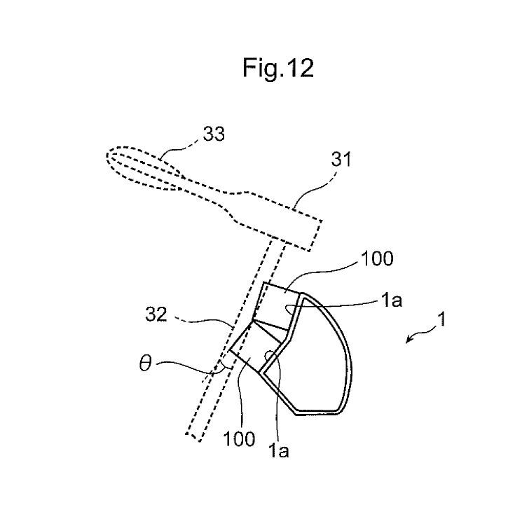

FIG. 12 shows another embodiment of the piano action in which the hammer cushion 100 is formed of two low repulsion urethane resin materials 101 that are divided in the longitudinal direction of the hammer shank 32.

Specifically, by individually slopping the upper surfaces 1a of the hammer rails 1, when rectangular shock absorbing materials 100 are placed thereon, as in the case of the embodiment shown in FIG. 5 in which protrusions are formed on both end portions of the hammer cushion 100, the effect in which, at the time of collision with the hammer shank 32, the hammer shank 32 comes into contact with both end positions of the shock absorbing material 100 first can be obtained.

Each hammer cushion (shock absorbing material) 100 itself is shaped to be rectangular in section without being sloped on the upper surface side, and accordingly, the hammer cushion has an angle (predetermined angle θ) to the contact surface of the hammer shank 32 when the hammer cushion is placed on the upper surface 1a of the hammer rail 1. In FIG. 10, portions constituted similar to those in FIG. 1 and FIG. 2 are designated by the same reference symbols.

In this example, the two shock absorbing materials 100 are entirely made of low repulsion urethane resin, respectively.

According to the respective embodiments described above, the hammer cushion (shock absorbing material) 100 is disposed on the hammer rail 1 at an angle so as not to become parallel to the contact surface of the hammer shank 32, so that the hammer shank 32 moves to come into contact with a part of the hammer cushion 100 first and then entirely come into contact with the hammer cushion due to subsequent warping of the shock absorbing material 100, so that an excellent shock absorbing effect can be obtained, and the rebounding position of the hammer 31 can be made stable and the operation can be stabilized.

Also, by reducing the area of the contact portion at the start of collision, the collision noise can be reduced.

As a result, even when a low repulsion resin material with a low coefficient of restitution is used as the hammer cushion (shock absorbing material) 100, in a case of playing by repeatedly striking a key at an extremely high speed, excellent playing reproducibility can be secured while continuously suppressing generation of collision noise.

1. A piano action comprising a plurality of hammers for striking strings; hammer shanks that support the respective hammers turnably; hammer rails that restrict the hammer shanks from turning after the hammers strike strings, and hammer cushions that are placed on the hammer rails and absorb motion energy generated by collision with the hammer shanks, wherein
the hammer cushions are disposed at an angle so as not to become parallel to contact surfaces of the hammer shanks.

2. The piano action according to claim 1, wherein the hammer cushions are shaped so that when the hammer shanks collide with the hammer cushions, the hammer shanks come into contact with parts of the hammer cushions first.

3. The piano action according to claim 1, wherein the hammer cushions are shaped so that when the hammer shanks collide with the hammer cushions, lower positions of the hammer shanks come into contact with the hammer cushions first.

4. The piano action according to claims 1, wherein each of the hammer cushions is made of low repulsion urethane resin.

5. The piano action according to claims 2, wherein each of the hammer cushions is made of low repulsion urethane resin.

6. The piano action according to claims 3, wherein each of the hammer cushions is made of low repulsion urethane resin.

7. The piano action according to claim 1, wherein each of the hammer cushions is made of a felt material and a low repulsion urethane resin material that are divided in the longitudinal direction of the hammer shank.

8. The piano action according to claim 5, wherein the low repulsion urethane resins of the hammer cushions are disposed at an angle so as not to become parallel to contact surfaces of the hammer shanks.
